(19) United States
(12) Patent Application Publication
(10) Pub. No.: US 2026/0153678 A1
(43) Pub. Date: Jun. 4, 2026

(54) SELF-ALIGNING OPTICAL FIBER INSERTION CONNECTOR SYSTEM AND METHOD

(71) Applicant: AT&T Intellectual Property I, L.P., Atlanta, GA (US)

(72) Inventors: Ricky A. Perry, Cumming, GA (US); Kirk D. Drane, McKinney, TX (US)

(73) Assignee: AT&T Intellectual Property I, L.P., Atlanta, GA (US)

(21) Appl. No.: 18/966,796

(22) Filed: Dec. 3, 2024

(51) Int. Cl. G02B 6/255

(52) U.S. Cl. CPC G02B 6/2555; G02B 6/2551

(57) ABSTRACT

Aspects of the subject disclosure may include, for example, splicing optical fibers using a self-aligning optical fiber insertion connector. An optical fiber is supported between an optical fiber tool and a fiber aligning cavity, and the optical fiber tool is translated towards the fiber aligning cavity to engage the optical fiber. The optical fiber is separated into a first optical fiber segment and a second optical fiber segment by translation of the optical fiber tool. The first and second optical fiber segments are aligned with respective first and second optical waveguides by further translation of the optical fiber tool to obtain splices of the first and second optical fiber segments to the respective first and second optical waveguides. Other embodiments are disclosed.

### FIELD OF THE DISCLOSURE

The subject disclosure relates to a self-aligning optical fiber insertion connector system and method.

### BACKGROUND

Optical fiber splicing is a critical process in the deployment and maintenance of fiber optic networks. It involves the joining of two optical fibers end-to-end to enable the transmission of light signals with minimal loss and reflection. This process is essential for extending the length of fiber optic cables, repairing damaged fibers, and generating access or insertion points, e.g., for interconnecting different network segments.

There are two primary methods of optical fiber splicing: fusion splicing and mechanical splicing. Fusion splicing is perhaps the most common method and involves the use of an electric arc to melt the ends of the fibers together, creating a continuous, low-loss optical path. This method provides a high-quality splice with minimal insertion loss and reflection, making it ideal for long-haul and high-performance applications. However, fusion splicing requires specialized equipment and skilled technicians, leading to higher labor costs, longer deployment times and challenges for implementing this process on fielded cables that may include large numbers of individual fibers, typically contained within a stiff cable jacket and often installed in hard to access suspended aerial configurations and/or subterranean configurations.

Mechanical splicing, on the other hand, involves the alignment and clamping of the fiber ends within a mechanical splice device. The fibers are held in place by an adhesive or a mechanical fixture, and index matching gel is often used to reduce signal loss at the splice point. While mechanical splicing is quicker and easier to perform than fusion splicing, it typically results in higher insertion loss and reflection, making it less suitable for long-distance or high-bandwidth applications.

One of the significant challenges associated with mechanical splicing is the difficulty in splicing larger fiber cable bundles. In optical distribution networks (ODNs), accessing and preparing larger main fiber cables for splicing can be labor-intensive and time-consuming. These larger cables are often rigid and difficult to handle, requiring extensive preparation to isolate individual fibers for splicing. This process involves opening the entire cable, cutting away protective sheaths, and preparing the fibers for splicing, which can be particularly challenging in field conditions.

Mechanical splicing of larger fiber cable bundles also presents issues with maintaining precise alignment and ensuring a secure connection. The rigidity of the cables and the need for precise alignment of multiple fibers can lead to increased insertion loss and reduced reliability of the splices. Additionally, the use of mechanical fixtures and adhesives can introduce variability in the quality of the splices, further complicating the process.

### BRIEF DESCRIPTION OF THE DRAWINGS

Reference will now be made to the accompanying drawings, which are not necessarily drawn to scale, and wherein:

FIGS. 1A and 1B are schematic diagrams illustrating cross sections of an example of a non-limiting embodiment of a self-aligning optical fiber insertion connector in accordance with various aspects described herein.

FIGS. 2A through 2D are schematic diagrams illustrating cross sections of an example of a non-limiting embodiment of a self-aligning optical fiber insertion connector in different operational configurations in accordance with various aspects described herein.

FIG. 3A is a schematic diagram providing three primary views of an orthographic projection of an example of a non-limiting embodiment of a cleaving assembly of a self-aligning optical fiber insertion connector in accordance with various aspects described herein.

FIG. 3B is a schematic diagram providing three primary views of an orthographic projection of an example of a non-limiting embodiment of a self-aligning an aligning assembly of a self-aligning optical fiber insertion connector in accordance with various aspects described herein.

FIG. 4A is a schematic diagram providing an elevation view of an example of a non-limiting embodiment of a self-aligning an aligning assembly of a mechanically actuated self-aligning optical fiber insertion connector in accordance with various aspects described herein.

FIG. 4B is a schematic diagram providing an elevation view of another example of a non-limiting embodiment of a self-aligning an aligning assembly of guided, self-aligning optical fiber insertion connector in accordance with various aspects described herein.

FIG. 4C is a schematic diagram providing an elevation view of another example of a non-limiting embodiment of a self-aligning an aligning assembly of an interlocking, self-aligning optical fiber insertion connector in accordance with various aspects described herein.

FIG. 4D is a schematic diagram providing an elevation view of yet another example of a non-limiting embodiment of a self-aligning optical fiber insertion connector in accordance with various aspects described herein.

FIG. 5 is a schematic diagram providing an elevation view of an example of a non-limiting embodiment of manual tool to actuate a self-aligning optical fiber insertion connector in accordance with various aspects described herein.

FIG. 6 depicts an illustrative embodiment of an example self-aligning optical fiber insertion connection process in accordance with various aspects described herein.

FIG. 7 depicts an illustrative embodiment of another example self-aligning optical fiber insertion connection process in accordance with various aspects described herein.

### DETAILED DESCRIPTION

The subject disclosure describes, among other things, illustrative embodiments for engaging an optical fiber within a connector having a cleaving member that is translatable with respect to an alignment member, such that translation of the cleaving member cleaves the optical fiber to obtain optical fiber segments that are aligned by the translation of the cleaving member with optical waveguides, such that the alignment results in mechanical splices of the optical fiber segments with the optical waveguides. Other embodiments are described in the subject disclosure.

One or more aspects of the subject disclosure include an optical fiber insertion connector, including a fiber cleaving assembly including a cleaving tool configured to cleave an optical fiber into first and second optical fiber segments having first and second cleaved fiber ends. The fiber cleaving assembly further includes a cleaving tool support member configured to guide the cleaving tool during a cleaving process of the optical fiber and first and second optical fiber bending surfaces secured relative to the cleaving tool support member and configured to bend the first and second cleaved fiber ends during an alignment process to obtain first and second fully bent cleaved fiber ends. The fiber insertion connector further includes a fiber alignment assembly including first and second optical fiber supports configured to support the optical fiber, before the cleaving process, at a first and second axially separated positions along the optical fiber. The fiber alignment assembly further includes first and second first optical fiber bearing surfaces configured to support the first and second optical fiber segments bent by the first and second optical fiber bending surfaces during the alignment process and first and second optical waveguides positioned to optically couple with the first and second fully bent cleaved fiber ends.

One or more aspects of the subject disclosure include a process for splicing optical fibers using a self-aligning optical fiber insertion connector that includes aligning an optical fiber with respect to an optical fiber cleaving tool to obtain an aligned optical fiber and supporting the aligned optical fiber at two axially separated locations to obtain a supported optical fiber. The process further includes moving the optical fiber cleaving tool in a first direction to a first position in contact with the supported optical fiber and cleaving the supported optical fiber between the two axially separated locations using the optical fiber cleaving tool to obtain separated first and second optical fiber ends. The process further includes continuing to move the optical fiber cleaving tool in the first direction to a second position located between the separated first and second optical fiber ends and continuing to move the optical fiber cleaving tool in the first direction to a third position, resulting in the alignment of the separated first and second optical fiber ends with respective optical fiber segments to obtain first and second optical fiber splices.

One or more aspects of the subject disclosure include a process for splicing optical fibers using a self-aligning optical fiber insertion connector. The process includes supporting an optical fiber between an optical fiber tool and a fiber aligning cavity, translating the optical fiber tool towards the fiber aligning cavity to engage the optical fiber, and separating the optical fiber into a first optical fiber segment and a second optical fiber segment by translation of the optical fiber tool. The process further includes aligning the first and second optical fiber segments with respective first and second optical waveguides by translation of the optical fiber tool and splicing the first and second optical fiber segments to the respective first and second optical waveguides by translation of the optical fiber tool.

Recent advancements in fiber optic technology have led to the development of innovative splicing solutions that aim to address these challenges. These solutions seek to reduce the labor and time required for splicing larger fiber cable bundles while maintaining low insertion loss and high reliability. One such innovation, the self-aligning optical fiber insertion connector, is the subject of this disclosure. The self-aligning technique simplifies the splicing process by allowing for quick and precise alignment and joining of fibers without the need for extensive cable preparation or specialized equipment, and often without the need for a substantial service loop.

The self-aligning optical fiber insertion connector represents a significant improvement over traditional splicing methods, offering a more efficient and cost-effective solution for fiber optic network deployment and maintenance. By reducing the complexity and labor associated with splicing, this technology has the potential to accelerate the rollout of high-speed fiber optic networks and improve the overall performance and reliability of optical communication systems.

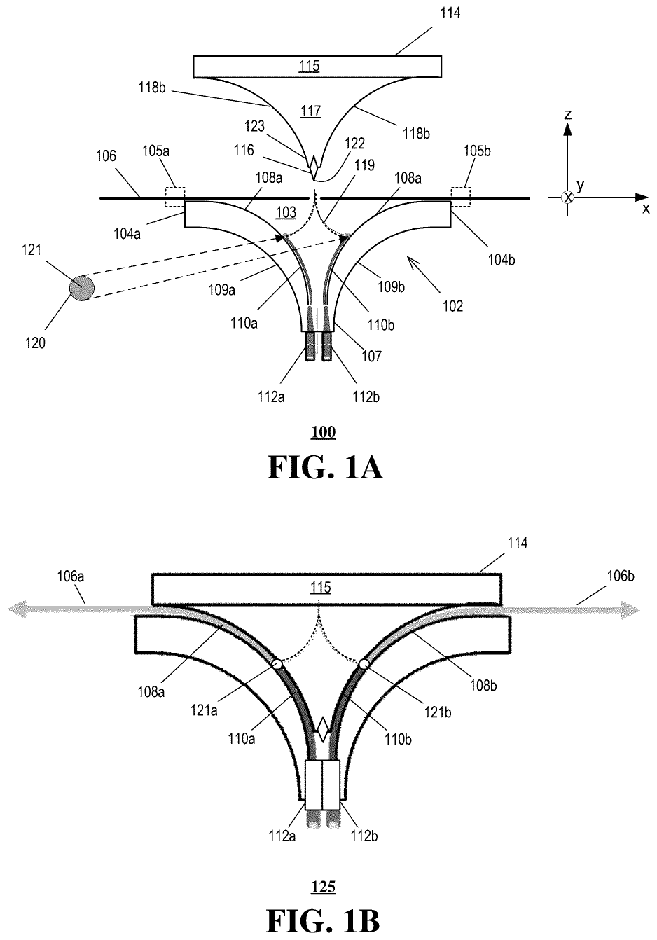

FIGS. 1A and 1B are schematic diagrams illustrating cross sections of an example of a non-limiting embodiment of a self-aligning optical fiber insertion connector, generally designated as 100 and 125, respectively, in accordance with various aspects described herein. According to the illustrative example, the self-aligning optical fiber insertion connector 100 includes a cleaving assembly 114 and a splice joining assembly 102. The cleaving assembly 114 includes a base member 115 and a protruding member 117 extending out from one side of the base member 115. At least a first portion of the protruding member 117 defines first optical fiber guiding surface 118a configured to guide a first segment of a cleaved optical fiber. At least a second portion of the protruding member 117 defines second optical fiber guiding surface 118b configured to guide a second segment of a cleaved optical fiber. As will be discussed further hereinbelow and in at least some embodiments, the guiding of the first and second segments of a cleaved optical fiber can be further configured to guide the first and second segments of the cleaved optical fiber into alignment with other optical waveguides, e.g., resulting in mechanical splices.

The cleaving assembly 114 also includes a cleaving tool 116, which is configured to cleave and/or otherwise cut an optical fiber 106 into a cleaved first optical fiber segment 106a and a cleaved second optical fiber segment 106b. In at least some embodiments, the cleaving tool 116 includes a cutting surface configured to separate the optical fiber 106 into the cleaved first and second optical fiber segments 106a, 106b. For example, the cleaving tool 116 can include a knife, e.g., a razor blade. Alternatively, or in addition, the cleaving tool 116 can include a sharp hardened surface, such as a polished gemstone, which may be formed naturally and/or according to a manufacturing process. In at least some embodiments, the cleaving tool 116 is configured to score an outer surface of the optical fiber allowing the cleaving process to occur responsive to tension applied to the optical fiber 106 in cooperation with and/or subsequent to the scoring process. For example, the tension to the optical fiber 106 may be provided at least in part by translation of the cleaving assembly 114 along an actuation direction, such that the cleaving tool 116 is urged into and beyond a fiber axis of the optical fiber 106.

It is understood that in at least some embodiments, the cleaving tool 116 includes a leading edge 122 that can provide a scoring and/or cutting surface. In at least some embodiments the leading edge 122 extends along a tool axis to provide a scoring and/or cutting surface in an orientation of the leading edge 122. In at least some embodiments, the fiber axis of the optical fiber 106 can be aligned with respect to the leading edge 122. For example, the fiber axis of the optical fiber 106 can be aligned perpendicular to the leading edge 122, such that the scoring or cutting occurs in a direction or plane that is perpendicular to the axis of the optical fiber 106.

In at least some embodiments, the protruding member 117 serves as a support for the cleaving tool 116. According to the illustrative example, the protruding member 117 terminates at a distal end 123, located at a farthest point measured away from the base member 115. This ensures that the cleaving tool 116 encounters the optical fiber 106 during actuation before any other portions of the cleaving assembly 114. For example, the cleaving tool 116 can be fixedly attached to the protruding member 117 at its distal end 123. Without limitation, the cleaving tool 116 cam be attached to the distal end 123 using one or more of a mechanical fastener, e.g., a screw, a clip, a friction fit, a notch and detent, a chemical fastener, e.g., a glue, and/or a thermal bonding process, e.g., a weld. As will be discussed further hereinbelow, the cleaving tool 116 can be guided by the distal end 123 of the protruding member 117 during actuation according to a cleaving process.

Further according to the illustrative embodiments, the splice joining assembly 102 includes a first fiber aligning member 109a including a first optical fiber support 104a and a second fiber aligning member 109b including a second optical fiber support 104b. The first fiber aligning member 109a extends from the first optical fiber support 104a to a lower connectorized end 107 of the splice joining assembly 102. Likewise, the second fiber aligning member 109b extends from the second optical fiber support 104b to the lower connectorized end 107. The first fiber aligning member 109a includes a first fiber bearing surface 108a extending between the first optical fiber support 104a and the lower connectorized end 107. Likewise, the second fiber aligning member 109b includes a second fiber bearing surface 108b extending between the second optical fiber support 104b and the lower connectorized end 107. The splice joining assembly 102 further defines an open interior region 103 positioned between first and second fiber bearing surfaces 108a, 108b.

In at least some embodiments, the splice joining assembly 102 includes a first optical waveguide 110a extending from the lower connectorized end 107 to a first splice point located along the first fiber bearing surface 108a, at a first predetermined location between the first optical fiber support 104a and the lower connectorized end 107. Likewise, the splice joining assembly 102 includes a second optical waveguide 110b extending from the lower connectorized end 107 to a second splice point located along the second fiber bearing surface 108a, at a second predetermined location between the second optical fiber support 104b and the lower connectorized end 107. According to the illustrative example, the first optical waveguide 110a is terminated by a first optical connector 112a at its lower end and presents a cleaved surface at its upper end that is adapted for splicing to the cleaved first optical fiber segment 106a. Likewise, the second optical waveguide 110b is terminated by a second optical connector 112b at its lower end and presents a cleaved surface at its upper end that is adapted for splicing to the cleaved second optical fiber segment 106b.

The first and second optical fiber supports 104a, 104b, generally 104, can be configured to align a fiber axis of the optical fiber 106 in anticipation for a cutting and/or cleaving process. For example, the optical fiber supports 104 may be positioned along a fiber alignment axis, such that a fiber axis of the optical fiber 106, when positioned thereon, is aligned according to the fiber alignment axis. It is understood that in at least some embodiments, the fiber alignment axis, e.g., positions of the optical fiber support 104 can be selected with respect to an orientation of the tool axis of the cleaving tool 116. A relative alignment of the fiber alignment axis and the tool axis can ensure that the optical fiber 106 is cleaved and/or otherwise cut according to a predetermined cleaving and/or cutting plane, e.g., at some angle relative to the optical fiber axis. In at least some embodiments, relative alignments are selected such that the cleaving and/or cutting plane is substantially perpendicular to the fiber axis of the optical fiber 106.

In some embodiments, the optical fiber supports 104 provide bearing surfaces upon which the optical fiber 106 is supported in preparation for a cleaving and alignment process, and in at least some embodiments, during at least a portion of and up to a conclusion of the cleaving and alignment process. According to the illustrative x-y-z-axes, the optical fiber 106 extending in an x-direction can supported by the optical fiber supports 104 to prevent motion of the optical fiber 106 in at least a z-direction during the cleaving and alignment process. Alternatively, or in addition the splice joining assembly 102 includes one or more features configured to contribute to alignment of the optical fiber 106 and/or retention of the optical fiber 106 and/or the cleaved first and second optical fiber segments 106a, 106b during the cleaving and alignment process.

It is envisioned that within at least some embodiments, the splice joining assembly 102 includes first and second fiber alignment devices 105a, 105b. In at least some embodiments, the first and second fiber alignment devices 105a, 105b, generally 105, can be configured prevent motion of the optical fiber and/or the cleaved first and second optical fiber segments 106a, 106b. The prevented motion can be provided in one or more of an axial direction, e.g., along the x-direction, which coincides with the fiber axis of the optical fiber 106. Alternatively, or in addition, the prevented motion can be provided along a y-direction, e.g., laterally with respect to the fiber axis of the optical fiber 106. In at least some embodiments, the prevented motion can be provided along the z-direction, e.g., preventing movement of the optical fiber 106 prior to cleaving and/or preventing movement of the cleaved first and second optical fiber segments 106a, 106b subsequent to cleaving. By way of example, the fiber alignment devices 105 may include any combination of an adhesive, e.g., a tape and/or glue and/or a clamp.

According to the illustrative embodiment, a relative motion between the cleaving assembly 114 and the splice joining assembly 102 occurs along the z-direction, e.g., with the cleaving assembly 114 initially positioned completely above the optical fiber 106, is moved, e.g., translated, along the z-direction, towards the optical fiber 106. Upon initiation of a cleaving and alignment process, the actuation of cleaving assembly 114 moves it along a z-direction until a cleaving portion the leading edge 122 of the cleaving tool 116 encounters the optical fiber 106. Continuing with the example cleaving and alignment process, a continued actuation of cleaving assembly 114 moves it along a z-direction, urging the protruding member 117 across the fiber axis of the optical fiber, thereby cleaving the optical fiber 106 into the cleaved first and second optical fiber segments 106a, 106b.

Continuing still further with the example cleaving and alignment process, a continued actuation of cleaving assembly 114 moves it still further along a z-direction, such that the distal end 123 of the protruding member 117 continues downward, progressing toward the lower connectorized end 107 of the spice joining assembly 102. As the protruding member 117 moves downward, the first optical fiber guiding surface 118a forces a cleaved end of the cleaved first optical fiber segment 106a to bend downward, towards the lower connectorized end 107. Likewise, the second optical fiber guiding surface 118b also forces a cleaved end of the second optical fiber segment 106b to bend downward, towards the lower connectorized end 107. As the cleaved ends of the cleaved first and second optical fiber segments 106a, 106b bend downwards, they follow a curved path 119 shown in phantom. In a terminal portion of the cleaving and alignment process, the distal end 123 of the protruding member 117 is proximate to the lower connectorized end 107, and the first optical fiber guiding surface 118a approaches the first fiber bearing surface 108a, with the cleaved first optical fiber segment 106a substantially entrapped therebetween. Likewise, the second optical fiber guiding surface 118b approaches the second fiber bearing surface 108b, with the cleaved second optical fiber segment 106b substantially entrapped therebetween.

At termination of the cleaving and alignment process, as illustrated in FIG. 1B, the cleaved end of the cleaved first optical fiber segment 106a is brought into a substantially abutting arrangement with a cleaved surface of an upper end of the first optical waveguide 110a, while the cleaved end of the cleaved second optical fiber segment 106b is brought into a substantially abutting arrangement with a cleaved surface of an upper end of the second optical waveguide 110b.

In at least some embodiments an index matching gel 121 can be provided in an abutting region of the cleaved first and second optical fiber segments 106a, 106b and the cleaved surfaces of the upper ends of the first and second optical waveguides 110a, 110b. For example, the splice joining assembly 102 can be preconfigured with the first and second optical waveguides 110a, 110b in place and positioned along adjacent portions of the first and second fiber bearing surfaces 108a, 108b. For example, the first and second optical waveguides 110a, 110b can be mechanically attached to the adjacent portions of the first and second fiber bearing surfaces 108a, 108b, chemically attached to the adjacent portions of the first and second fiber bearing surfaces 108a, 108b and/or otherwise bonded, e.g., welded to the adjacent portions of the first and second fiber bearing surfaces 108a, 108b.

Alternatively, or in addition, the first and second optical waveguides 110a, 110b can be fixedly attached to the first and second optical termination connectors 112a, 112b, while remaining otherwise unattached to the first and second fiber bearing surfaces 108a, 108b. In such instances, it is understood that actuation of the cleaving assembly 114, including movement of the protruding member 117 toward the toward the lower connectorized end 107, can similarly force the free ends of the first and second optical waveguides 110a, 110b towards the first and second fiber bearing surfaces 108a, 108b until they are brought into substantially abutting arrangements the cleaved ends of the cleaved first and second optical fiber segment 106a, 106b. In such instances, it is possible that the first and second optical waveguides 110a, 110b are held into the abutting arrangement by entrapment between the first and second optical fiber guiding surfaces 118a, 118b approaches the first and second fiber bearing surfaces 108a, 108b.

In at least some embodiments, the index matching gel 121 can be contained within rupturable gel package 120 preconfigured at the cleaved ends of the first and second optical waveguides 110a, 110b, and/or at the abutting locations along the first and second fiber bearing surfaces 108a, 108b. It is understood that an actuation of the cleaving assembly 114, e.g., bringing the first and second optical fiber guiding surfaces 118a, 118b in proximity to the first and second fiber bearing surfaces 108a, 108b can rupture the rupturable gel package 121, e.g., disbursing the indexing matching gel 121 in proximity to the abutting region. Thus, upon engagement of the cleaving assembly 114 with the splice joining assembly 102, the rupturable gel package 120 releases the index matching gel 121, facilitating the joining and sealing of the cleaved first and second optical fiber segments 106a and 106b with the respective first and second optical waveguides 110a and 110b.

In summary, FIG. 1A and FIG. 1B illustrate the components and operation of the self-aligning optical fiber insertion connector 100, 125, highlighting the cleaving, aligning, and joining processes that enable efficient and precise splicing of optical fibers.

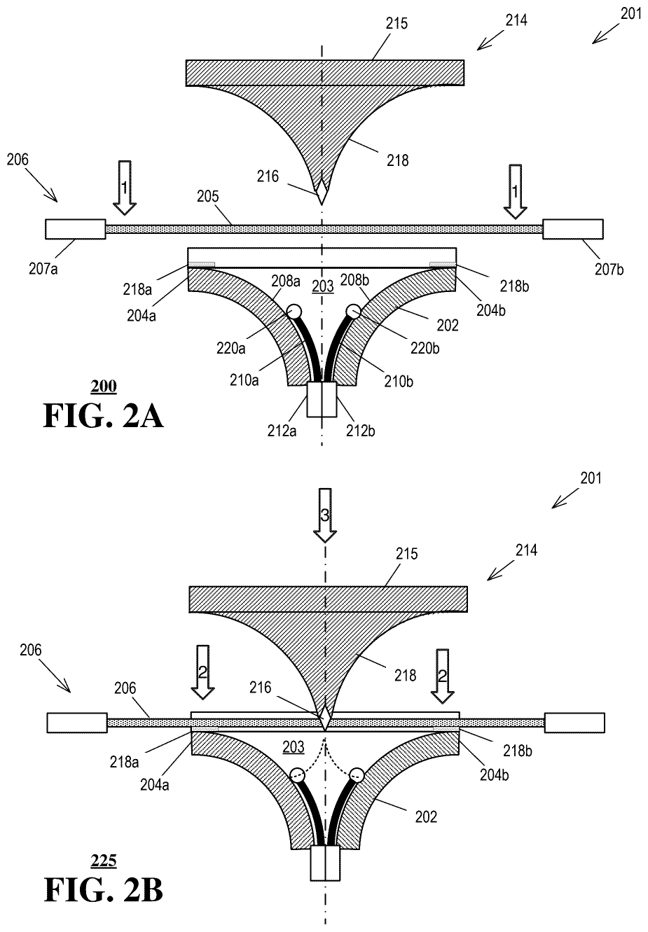

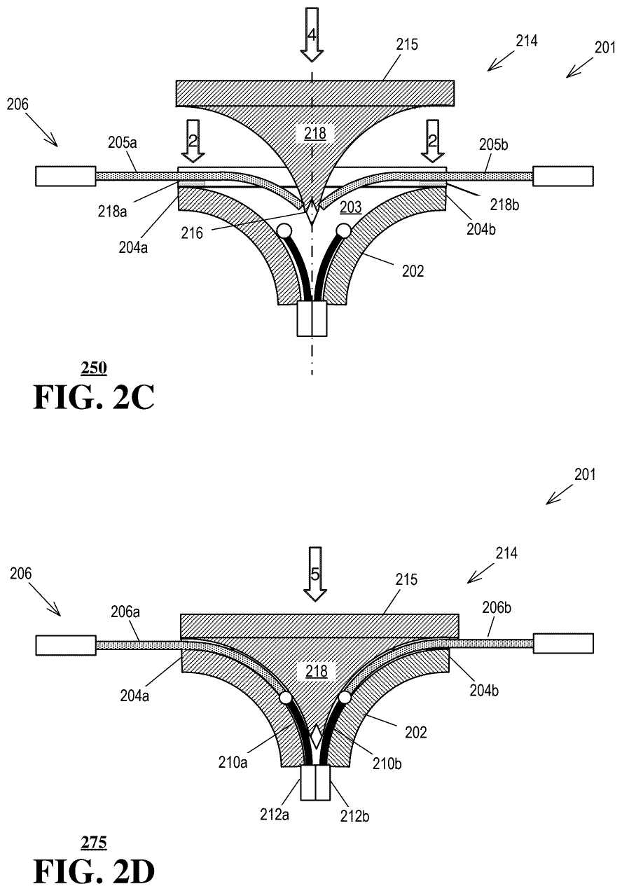

FIGS. 2A through 2D illustrate cross-sectional views of an example embodiment of a self-aligning optical fiber insertion connector 201 in different operational configurations, generally designated as 200, 225, 250, and 275, respectively, in accordance with various aspects described herein. Referring to FIG. 2A, the self-aligning optical fiber insertion connector 201 includes a cleaving assembly 214 and a connector joining assembly 202. The cleaving assembly 214 includes a base member 215 and a protruding member 217 extending out from one side of the base member 215. At least a first portion of the protruding member 217 defines first optical fiber guiding surface 218 configured to guide cleaved first and second segments of the optical fiber cable 206. The cleaving assembly 214 also includes a cleaving tool 216, which is configured to cleave and/or otherwise cut the optical fiber cable 206 into a first optical fiber segment 205a and a second optical fiber segment 205b. In at least some embodiments, the cleaving tool 216 is configured to facilitate separation of the optical fiber cable 206 into the first and second optical fiber segments 205a, 205b.

Still referring to FIG. 2A, the optical fiber cleaving connector 201 is shown in a pre-engagement or starting configuration 200 in which a jacketed optical fiber cable 206 has been reconfigured, e.g., stripped, to expose a segment of optical fiber strand 205 over a length extending between a first jacketed segment of the optical fiber cable 207a and a second jacketed segment of the optical fiber cable 207b. According to the pre-configuration or starting configuration 200, the optical fiber cable is placed onto first and second optical fiber supporting members 204a, 204b of the connector joining assembly 202. For example, a positioning force “1” is applied to the ends of the optical fiber cable 206 to bring adjacent portions of the exposed optical fiber strand 205 into contact with the first and second optical fiber supporting members 204a, 204b. In at least some embodiments, the first and second optical fiber supporting members 204a, 204b include first and second adhesive regions 218a, 218b configured to affix the exposed optical fiber strand 205 to the first and second supporting members, with an exposed center region extending between the first and second adhesive regions spanning an open area 203 or aperture of the connector joining assembly 202.

Referring to FIG. 2B, the self-aligning optical fiber insertion connector 201 is shown in a cleaving configuration 225 in an actuation force “3” is applied to the base member, causing the base member 215 to translate towards the connector joining assembly 202, until the which the cleaving assembly 214 has been urged from a position above the optical fiber cable 206, down onto the optical fiber cable 206, such that the cleaving tool 216 engages an exposed optical fiber strand 205 between the first and second optical fiber supporting members 204a, 204b. In some embodiments, the first and second adhesive regions 218a, 218b and/or fiber-retaining clamps are configured to exert a retaining force “2” configured to retain the exposed optical fiber strand 205 in place while the cleaving assembly 214 is urged into the exposed optical fiber strand 205 to cause a cutting, cleaving and/or separation of the first and second optical fiber segments 205a, 205b.

Referring to FIG. 2C, the optical fiber cleaving connector 201 is shown in a post cleaved, and pre-spliced aligning configuration 250 in which the first and second optical fiber segments 205a, 205b of the cleaved optical fiber cable 206 are separated. The first and second optical fiber segments 205a, 205b are urged downward by the optical fiber guiding surface 218 of the protruding member 217 as the cleaving assembly 214 continues to advance downward.

Referring to FIG. 2D, the optical fiber cleaving connector 201 is shown in a fully engaged configuration 275 in which the first and second optical fiber segments 205a and 205b are aligned with first and second optical waveguides 210a and 210b, respectively. The cleaving assembly 214 is fully engaged with the connector joining assembly 202, such that mechanical splices are formed between the first and second optical fiber segments 205a, 205b and proximal ends of the first and second optical waveguides 210a, 210b. The distal ends of the first and second optical termination connectors 212a and 212b, in turn, are in communication with first and second optical termination connectors 212a, 212b, such that a breakout and/or insertion point is obtained into the optical fiber cable 206 via the first and second optical termination connectors 212a, 212b.

In summary, FIGS. 2A through 2D illustrate the sequential steps of the self-aligning optical fiber insertion connector, highlighting the cleaving, aligning, and joining processes that enable efficient and precise splicing of optical fibers. It is understood that in at least some embodiments, a single actuation of the optical fiber cleaving connector 201 cleaves the optical fiber cable, aligns the cleaved ends of the optical fiber cable 206 and obtains mechanical optical fiber splices to other optical waveguides or fibers that may be optical communication with first and second optical termination connectors 212a, 212b.

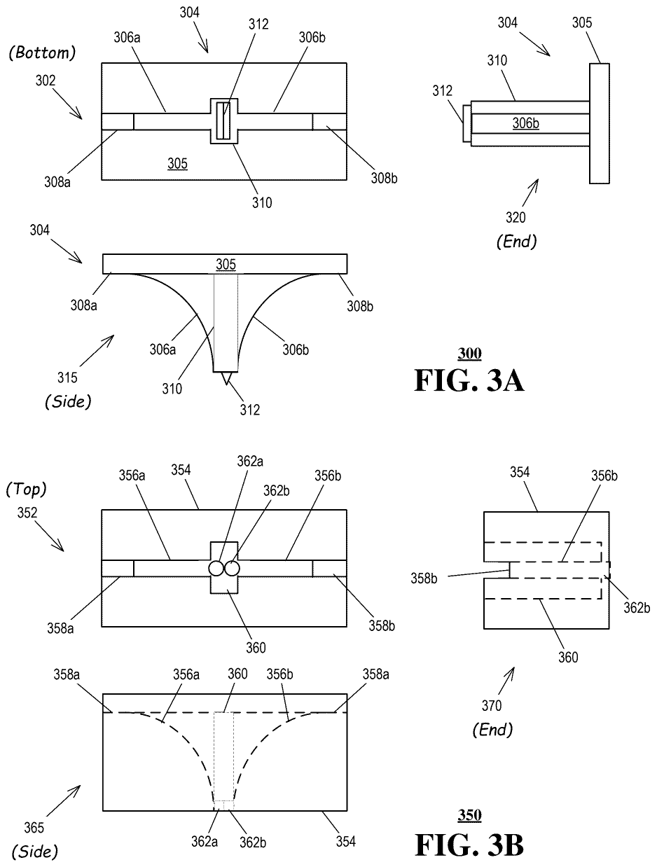

FIG. 3A is a schematic diagram providing three primary views of an orthographic projection of an example of a non-limiting embodiment of a cleaving assembly of a self-aligning optical fiber insertion connector, generally designated as 304, in accordance with various aspects described herein. Referring to the bottom view 302, the cleaving assembly 304 includes a base portion 305 supporting a first optical fiber guiding surface 306a and a second optical fiber guiding surface 306b. These guiding surfaces are configured to support and guide an optical fiber during a cleaving process and/or an alignment process. The cleaving assembly 304 also includes a first optical fiber supporting surface 308a and a second optical fiber supporting surface 308b, which provide additional support to the optical fiber, e.g., after the splices have been formed to contribute holding the fiber ends in place, e.g., by a clamping action.

The base portion 305 further includes a cleaving tool 312 that may be centrally located. In at least some embodiments, the cleaving tool 312 may be supported by a support member 310. The cleaving tool support member 310 can be used to ensure that the cleaving tool 312 is precisely guided during actuation, e.g., during an initial alignment procedure, during a cleaving procedure, during an alignment procedure and/or during a splicing procedure, allowing for accurate mechanical splicing of an optical fiber.

Referring to a side view 315 of the cleaving assembly 304, the first optical fiber guiding surface 306a and the second optical fiber guiding surface 306b are shown in relation to the cleaving tool support member 310 and the cleaving tool 312. The side view 315 also illustrates the first optical fiber supporting surface 308a and the second optical fiber supporting surface 308b, which are positioned to provide stability to the optical fiber during the cleaving process.

Referring to the end view 320 of the cleaving assembly 300, the cleaving tool 312 is shown extending from the cleaving tool support member 310. The first optical fiber guiding surface 306a and the second optical fiber guiding surface 306b are positioned on either side of the cleaving tool 312, ensuring that the optical fiber is properly aligned and supported during the cleaving process.

In summary, FIG. 3A illustrates the structural components of the cleaving assembly 300, highlighting the arrangement of the optical fiber guiding surfaces, supporting surfaces, cleaving tool, and cleaving tool support member. These components work together to facilitate the precise and efficient cleaving of an optical fiber, which is a critical step in the self-aligning optical fiber insertion connector process.

FIG. 3B is a schematic diagram providing three primary views of an orthographic projection of an example of a non-limiting embodiment of a connector joining assembly of a self-aligning optical fiber insertion connector, generally designated as 354, in accordance with various aspects described herein. Referring to a top view 352, the connector joining assembly 354 includes a first optical fiber bearing surface 356a and a second optical fiber bearing surface 356b. These bearing surfaces 356a, 356b are configured to support the first and second optical fiber segment during alignment process in which the cleaved optical fiber segments are mechanically spliced with first and second optical waveguides 362a and 362b. The connector joining assembly 354 also includes a first optical fiber supporting surface 358a and a second optical fiber supporting surface 358b, which provide additional support to the optical fiber segments during the alignment process. The cleaving tool support member guiding channel 360 can be centrally located and is configured to guide the cleaving tool support member during the cleaving process, ensuring precise alignment and engagement of the cleaving tool with the optical fiber segments.

Referring to the side view 365 of the connector joining assembly 354, the first optical fiber bearing surface 356a and the second optical fiber bearing surface 356b are shown in relation to the cleaving tool support member guiding channel 360 and the first and second optical waveguides 362a and 362b. The side view 365 also illustrates the first optical fiber supporting surface 358a and the second optical fiber supporting surface 358b, which are positioned to provide stability to the optical fiber segments during the alignment process.

Referring to the end view 370 of the connector joining assembly 354, the first optical fiber bearing surface 356b and the second optical fiber bearing surface 356b are positioned on either side of the cleaving tool support member guiding channel 360, ensuring that the optical fiber segments are properly aligned and supported during the joining process. The first and second optical waveguides 362a and 362b are also shown extending from the connector joining assembly 354.

In summary, FIG. 3B illustrates the structural components of the connector joining assembly 354, highlighting the arrangement of the optical fiber aligning surfaces, supporting surfaces, cleaving tool support member guiding channel, and optical waveguides. The cleaving assembly 304 and the connector joining assembly 354 can be configured for a slidable engagement. The sliding engagement can include actuation of an optical fiber splicing and alignment process in which an optical fiber cable can be cleaved and mechanically spliced with a single action, e.g., a single movement, such as the example advancement of the connector joining assembly 354. These components work together to facilitate the precise and efficient alignment and joining of optical fiber segments, which is a critical step in the self-aligning optical fiber insertion connector process.

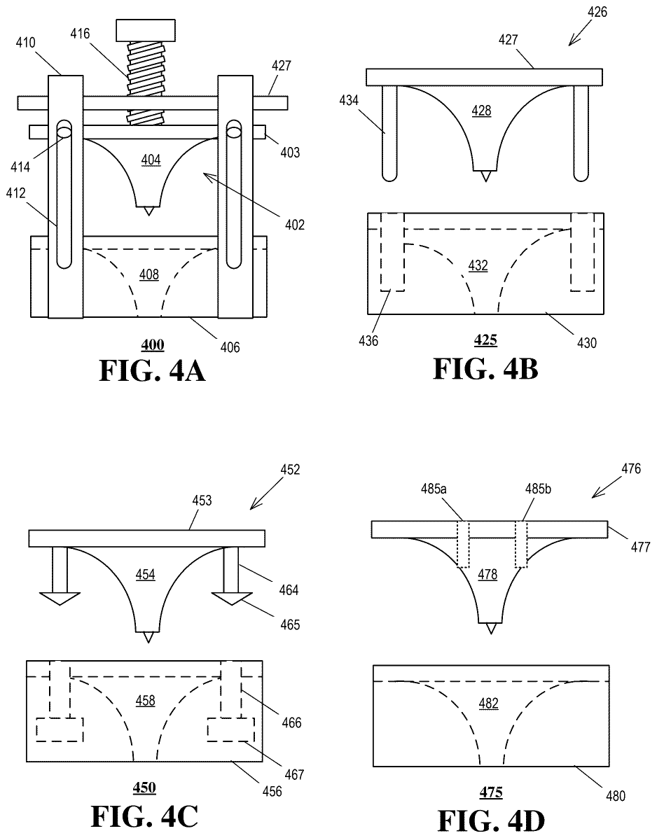

FIG. 4A is a schematic diagram providing an elevation view of an example of a non-limiting embodiment of a self-aligning optical fiber cleaving connector, generally designated as 400, in accordance with various aspects described herein. The optical fiber cleaving connector 400 includes an optical fiber connector cleaving assembly 402 and an optical fiber joining assembly 406. The cleaving assembly 402 includes a base member outfitted with a protruding member 404, which is configured to engage with an optical fiber during the cleaving process. In at least some embodiments, the cleaving assembly 402 and the optical fiber joining assembly 406 are coupled to a connector guiding frame 410. The connector guiding frame 410 can be fixedly attached at one end to the fiber joining assembly and slidably attached at another end to the cleaving assembly 402. For example, the guiding frame 410 can include a guiding slot or track 412 extending longitudinally between the cleaving assembly 402 and the fiber joining assembly. The cleaving assembly 402 can be configured with a guiding pin 414 configured for slidable engagement along the guiding slot or track 412. The sliding engagement permits movement of the cleaving assembly 402 with respect to the optical fiber joining assembly 406.

The guiding frame 410 is configured to permit the cleaving assembly 402 to be raised completely above ethe optical fiber joining assembly 406, such that an optical fiber may be positioned therebetween. The optical fiber joining assembly 406 includes a receptacle 408, which is configured to receive the protruding member 404 of the cleaving assembly 402. In operation, the cleaving assembly 402 is actuated to move towards the optical fiber joining assembly 406 until at least a substantial portion of the protruding member 404 has entered into the receptacle 408.

According to the illustrative example, an actuator 416 is provided to apply a necessary force to the base portion 403 of the cleaving assembly 402. The actuation fore moves the cleaving assembly in a downward direction, enabling it to cleave the optical fiber and align the cleaved segments withing the optical fiber joining assembly 406. It is envisioned that a resilient member, e.g., spring and/or elastomeric member, and/or a compressible foam may be applied in such a manner so as to counteract the actuation force, e.g., to prevent the cleaving assembly 402 from unrestricted movement in which it may fall into the receptacle 408 and/or otherwise damage the optical fiber. In some embodiments, the actuator 416 can be manually operated, e.g., using a spring, a screw, a ramp, a pulley and/or any combination of simple machines. Alternatively, or in addition, the actuator 416 may be powered, e.g., electrically powered such that activation of the actuator by applying an electrical stimulus actuates a cleaving and alignment process.

In summary, FIG. 4A illustrates the structural components and operation of the self-aligning optical fiber cleaving connector 400, highlighting the cleaving, aligning, and joining processes that enable efficient and precise splicing of optical fibers. The diagram emphasizes the role of the cleaving assembly 402, the optical fiber joining assembly 406, the connector guiding frame 410, and the actuator 416 in achieving accurate and reliable fiber splicing.

FIG. 4B is a schematic diagram providing an elevation view of an example of a non-limiting embodiment of a guided, self-aligning optical fiber cleaving connector, generally designated as 425, in accordance with various aspects described herein. The optical fiber cleaving connector 425 includes a cleaving assembly 426 and a fiber joining assembly 430. The cleaving assembly 426 includes a protruding end 428 extending from a base portion 427 and configured to engage with an optical fiber during a cleaving and alignment process. According to the illustrative embodiment, the cleaving assembly 426 includes one or more connector guiding pins 434. The fiber joining assembly 430 is configured with connector guiding channels 436. The channels 436 are sized and shaped to accept a slidable engagement with the connector guiding pins 434.

In operation, the cleaving assembly 426 can be guided towards a fiber joining assembly 430 by a slidable engagement of the connector guiding pins 434 and the connector guiding channels. The connector guiding pins 434 and channels 436 are configured to ensure precise alignment and engagement with the fiber joining assembly 430.

In at least some embodiments, the fiber joining assembly 430 includes a receptacle 432, which is configured to receive the protruding end 428, such that the slidable engagement of the connector guiding pins 434 and channels 436 facilitate the alignment and engagement of the cleaving assembly 426 with the fiber joining assembly 430, ensuring that the optical fiber segments are properly aligned and supported during the joining process.

In summary, FIG. 4B illustrates the structural components and operation of the guided, self-aligning optical fiber cleaving connector 425, highlighting the cleaving, aligning, and joining processes that enable efficient and precise splicing of optical fibers. The diagram emphasizes the role of the cleaving assembly 426, fiber joining assembly 430, protruding end 428, receptacle 432, and connector guiding pins 434 and channels 436 in achieving accurate and reliable fiber splicing.

FIG. 4C is a schematic diagram providing an elevation view of an example of a non-limiting embodiment of an interlocking, self-aligning optical fiber insertion connector, generally designated as 450, in accordance with various aspects described herein. The interlocking, self-aligning optical fiber cleaving connector 450 includes an optical fiber cleaving assembly 452 and an optical fiber joining assembly 456. The optical fiber cleaving assembly 452 includes a protruding end 454, which is configured to engage with the optical fiber during a cleaving and alignment process. The optical fiber cleaving assembly 452 is further equipped with one or more connector guiding pins 464, which ensure precise alignment and engagement with the fiber joining assembly 456.

The fiber joining assembly 456 includes a receptacle 458, which is configured to receive the cleaved optical fiber segments as guided by the protruding end 454. The connector guiding pins 464 are designed to fit into connector guiding pin sockets 466 within the fiber joining assembly 456. Additionally, the guiding pins 464 have lockable features 465 that engage with guiding pin locking receptacles 467 in the fiber joining assembly 456, ensuring that the optical fiber cleaving assembly 452 and the fiber joining assembly 456 are securely locked together during the splicing process.

In summary, FIG. 4C illustrates the structural components and operation of the interlocking, self-aligning optical fiber cleaving connector 450, highlighting the cleaving, aligning, and joining processes that enable efficient and precise splicing of optical fibers. The diagram emphasizes the role of the optical fiber cleaving assembly 452, fiber joining assembly 456, protruding end 454, receptacle 458, connector guiding pins 464, guiding pin sockets 466, lockable features 465, and locking receptacles 467 in achieving accurate and reliable fiber splicing.

FIG. 4D is a schematic diagram providing an elevation view of yet another example of a non-limiting embodiment of a self-aligning optical fiber insertion connector, generally designated as 475, in accordance with various aspects described herein. The optical fiber cleaving connector 475 includes an optical fiber connector cleaving assembly 476 and an optical fiber joining assembly 480. The cleaving assembly 476 includes a protruding end 478, which is configured to engage with an optical fiber during the cleaving process. The cleaving assembly 476 is designed to ensure precise alignment and engagement with the fiber joining assembly 480.

The fiber joining assembly 480 includes a receptacle 482, which is configured to receive the cleaved optical fiber segments as guided at least in part by the protruding end 478 as it extends into the receptacle 482. The receptacle 482 ensures that the optical fiber segments are properly aligned and supported during the joining process.

The cleaving assembly 476 further includes a first gel filling port 485a and a second gel filling port 485b. These gel filling ports can be configured to allow for the introduction of index matching gel into the fiber joining assembly 480 during and/or after a cleaving, aligning and splicing process. The index matching gel facilitates the joining and sealing of the cleaved optical fiber segments with the respective optical waveguides, ensuring a low-loss optical connection.

In summary, FIG. 4D illustrates the structural components and operation of the self-aligning optical fiber cleaving connector 475, highlighting the cleaving, aligning, and joining processes that enable efficient and precise splicing of optical fibers. The diagram emphasizes the role of the cleaving assembly 476, fiber joining assembly 480, protruding end 478, receptacle 482, and gel filling ports 485a and 485b in achieving accurate and reliable fiber splicing.

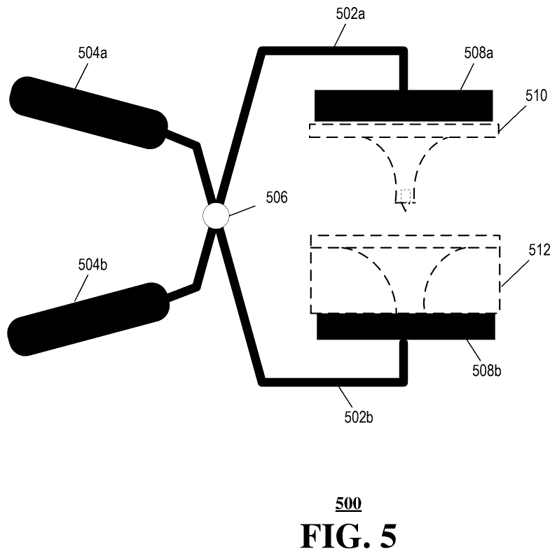

FIG. 5 is a schematic diagram providing an elevation view of an example of a non-limiting embodiment of a compression tool, generally designated as 500, to actuate a self-aligning optical fiber insertion connector in accordance with various aspects described herein. The compression tool 500 is designed to facilitate the engagement of a cleaving assembly 510 and a connector joining assembly 512 of a self-aligning optical fiber insertion connector by compression, clamping and/or otherwise translating mating connector portions with respect to each other. The tool 500 includes a first tool lever 502a and a second tool lever 502b, which are connected via a pivot joint 506. The first tool lever 502a includes a first lever handle 504a, and the second tool lever 502b includes a second lever handle 504b, allowing for manual operation of the tool 500, e.g., by bringing the handles 504a, 504b, generally 504, closer together to provide a clamping force and separating the handles 504 to remove the clamping force.

The first tool lever 502a is equipped with a first lever jaw 508a, and the second tool lever 502b is equipped with a second lever jaw 508b. These lever jaws 508a, 508b, generally 508, are designed to apply pressure to the cleaving assembly 510 and the connector joining assembly 512, respectively, ensuring precise alignment and engagement during a cleaving and joining process.

When the handles 504 are squeezed together, the lever jaws 508 move towards each other, applying a controlled and even pressure to the cleaving assembly 510 and the connector joining assembly 512. This action ensures that the optical fiber is cleaved, and the segments are aligned and joined with the respective optical waveguides in a precise and reliable manner.

In summary, FIG. 5 illustrates the structural components and operation of the compression tool 500, highlighting the role of the tool levers, lever handles, lever jaws, and pivot joint in facilitating the engagement of the cleaving assembly and the connector joining assembly. The diagram emphasizes the importance of controlled and even pressure application in achieving accurate and reliable fiber splicing.

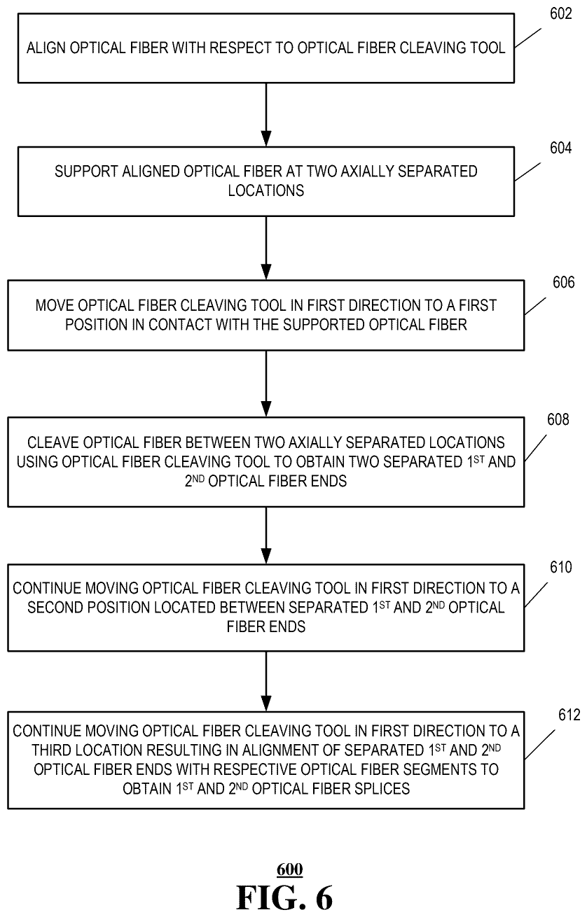

FIG. 6 depicts an illustrative embodiment of an example self-aligning optical fiber insertion connection process, generally designated as 600, in accordance with various aspects described herein. This process 600 is designed to facilitate the precise and efficient splicing of optical fibers using the self-aligning optical fiber insertion connector described in the disclosure and illustrated in the other figures.

The process 600 begins at step 602, where an optical fiber is aligned with respect to an optical fiber cleaving tool. This step ensures that the optical fiber is properly positioned for the subsequent cleaving and splicing operations. The alignment is facilitated by the first and second optical fiber guiding surfaces, e.g., described in FIG. 1A and FIG. 1B.

At step 604, the aligned optical fiber is supported at two axially separated locations. This support is provided by the first and second optical fiber supporting surfaces, e.g., as illustrated in FIG. 3A and FIG. 3B. Supporting the optical fiber at these locations ensures stability and precision during the cleaving process.

In step 606, the optical fiber cleaving tool is moved in a first direction to a first position in contact with the supported optical fiber. The cleaving tool guided by the cleaving tool support members, e.g., as shown in FIG. 3A, is positioned to initiate the cleaving process.

At step 608, the optical fiber is cleaved between the two axially separated locations using the optical fiber cleaving tool. This action results in two separated optical fiber ends, designated as the first and second optical fiber ends. The cleaving tool's precise action is critical for ensuring clean and accurate fiber ends, e.g., as described in FIG. 1A and FIG. 1B.

In step 610, the optical fiber cleaving tool continues to move in the first direction to a second position located between the separated first and second optical fiber ends. This movement aligns the cleaved fiber ends with the respective optical fiber segments, preparing them for the splicing process.

Finally, at step 612, the optical fiber cleaving tool continues to move in the first direction to a third location, resulting in the alignment of the separated first and second optical fiber ends with the respective optical fiber segments. This alignment facilitates the splicing of the optical fibers, resulting in first and second optical fiber splices. The use of index matching gel, as described in FIG. 1A and FIG. 1B, ensures a low-loss optical connection.

In summary, FIG. 6 illustrates the sequential steps of the self-aligning optical fiber insertion connection process 600, highlighting the alignment, support, cleaving, and splicing operations that enable efficient and precise splicing of optical fibers. This process 600 leverages the structural components and mechanisms described in the other figures to achieve accurate and reliable fiber splicing.

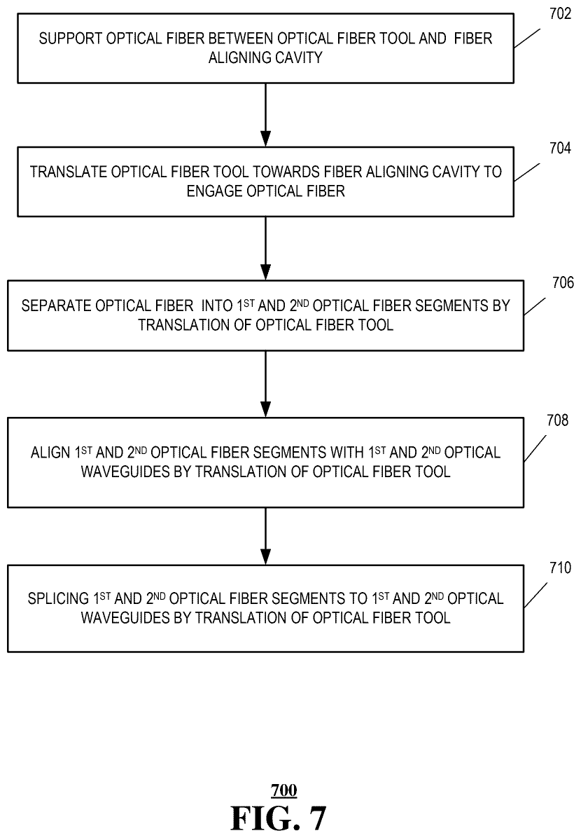

FIG. 7 depicts an illustrative embodiment of another example self-aligning optical fiber insertion connection process 700 in accordance with various aspects described herein. This process 700 is designed to facilitate the precise and efficient splicing of optical fibers using the self-aligning optical fiber insertion connector described in the disclosure and illustrated in the other figures.

The process begins at step 702, where an optical fiber is supported between an optical fiber tool and a fiber aligning cavity. This step ensures that the optical fiber is properly positioned for the subsequent cleaving and splicing operations. The support is facilitated by the first and second optical fiber guiding surfaces, e.g., described in FIG. 1A and FIG. 1B.

At step 704, the optical fiber tool is translated towards the fiber aligning cavity to engage the optical fiber. This movement is guided by the cleaving tool support member, e.g., as shown in FIG. 3A, ensuring precise engagement with the optical fiber.

In step 706, the optical fiber is separated into a first optical fiber segment and a second optical fiber segment by the translation of the optical fiber tool. The cleaving tool, e.g., as described in FIG. 1A and FIG. 1B, performs the cleaving action, resulting in two separated optical fiber segments.

At step 708, the first and second optical fiber segments are aligned with respective first and second optical waveguides by the continued translation of the optical fiber tool. The alignment is facilitated by the first and second optical fiber aligning surfaces, e.g., as illustrated in FIG. 3B, ensuring that the optical fiber segments are properly positioned for splicing.

Finally, at step 710, the first and second optical fiber segments are spliced to the respective first and second optical waveguides by the continued translation of the optical fiber tool. The use of index matching gel, e.g., as described in FIG. 1A and FIG. 1B, ensures a low-loss optical connection, resulting in first and second optical fiber splices.

In summary, FIG. 7 illustrates the sequential steps of the self-aligning optical fiber insertion connection process 700, highlighting the support, engagement, separation, alignment, and splicing operations that enable efficient and precise splicing of optical fibers. This process leverages the structural components and mechanisms described in the other figures to achieve accurate and reliable fiber splicing.

While for purposes of simplicity of explanation, the respective processes are shown and described as a series of blocks in FIGS. 6 and 7, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications that can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. An optical fiber insertion connector, comprising:
a fiber cleaving assembly comprising:
a cleaving tool configured to cleave an optical fiber into first and second optical fiber segments having first and second cleaved fiber ends;
a cleaving tool support member configured to guide the cleaving tool during a cleaving process of the optical fiber; and
first and second optical fiber bending surfaces secured relative to the cleaving tool support member and configured to bend the first and second cleaved fiber ends during an alignment process to obtain first and second fully bent cleaved fiber ends; and
a fiber alignment assembly comprising:
first and second optical fiber supports configured to support the optical fiber, before the cleaving process, at a first and second axially separated positions along the optical fiber;
first and second first optical fiber bearing surfaces configured to support the first and second optical fiber segments bent by the first and second optical fiber bending surfaces during the alignment process; and
first and second optical waveguides positioned to optically couple with the first and second fully bent cleaved fiber ends.

2. The optical fiber insertion connector of claim 1, wherein the fiber alignment assembly further comprises:
an index matching gel to facilitate a joining and sealing of the first and second cleaved fiber ends with the first and second optical waveguides.

3. The optical fiber insertion connector of claim 2, wherein the fiber alignment assembly further comprises:
a rupturable gel package containing the index matching gel and configured to release the index matching gel upon engagement of the fiber cleaving assembly with the fiber alignment assembly.

4. The optical fiber insertion connector of claim 2, wherein the fiber alignment assembly further comprises:
a gel filling port configured to allow for an introduction of the index matching gel into the fiber alignment assembly.

5. The optical fiber insertion connector of claim 1, wherein the first and second optical fiber supports further comprise an adhesive positioned to securely fasten the first and second optical fiber segments to the first and second optical fiber supports.

6. The optical fiber insertion connector of claim 1, wherein connector joining assembly further comprises:
a first optical termination device and a second optical termination device configured to terminate the first and second optical waveguides, respectively.

7. The optical fiber insertion connector of claim 6, wherein at least one of the first and second optical termination devices comprises one of a lucent connector (LC), a standard connector (SC), an ST connector, a ferrule core (FC) connector, a multi-position optical (MPO) connector, or an MT-RJ connector.

8. The optical fiber insertion connector of claim 7, wherein the at least one of the first and second optical termination devices comprises a bulkhead connector.

9. The optical fiber insertion connector of claim 1, wherein at least one of the first and second optical waveguides comprises an optical fiber.

10. The optical fiber insertion connector of claim 1, further comprising:
an actuator in communication with at least one of the fiber cleaving assembly and the fiber alignment assembly, wherein the actuator is configured to change a separate distance between the fiber cleaving assembly and the fiber alignment assembly.

11. The optical fiber insertion connector of claim 1, wherein the cleaving tool comprises a knife edge configured to precisely cleave the optical fiber.

12. A method for splicing optical fibers using a self-aligning optical fiber insertion connector, comprising:
aligning an optical fiber with respect to an optical fiber cleaving tool to obtain an aligned optical fiber;
supporting the aligned optical fiber at two axially separated locations to obtain a supported optical fiber;
moving the optical fiber cleaving tool in a first direction to a first position in contact with the supported optical fiber;
cleaving the supported optical fiber between the two axially separated locations using the optical fiber cleaving tool to obtain separated first and second optical fiber ends;
continuing to move the optical fiber cleaving tool in the first direction to a second position located between the separated first and second optical fiber ends; and
continuing to move the optical fiber cleaving tool in the first direction to a third position, resulting in the alignment of the separated first and second optical fiber ends with respective optical fiber segments to obtain first and second optical fiber splices.

13. The method of claim 12, wherein the optical fiber cleaving tool comprises a cleaving assembly and a connector joining assembly, and the method further comprises:
using a compression tool to engage the cleaving assembly with the connector joining assembly.

14. The method of claim 12, wherein an index matching gel is contained within a rupturable gel package that releases the index matching gel upon engagement of the optical fiber cleaving tool with the separated first and second optical fiber ends.

15. The method of claim 12, wherein the optical fiber cleaving tool comprises a cleaving assembly and a connector joining assembly, and the method further comprises:
engaging the cleaving assembly with the connector joining assembly to align and splice the first and second optical fiber ends with the respective optical fiber segments.

16. The method of claim 15, further comprising:
using a compression tool to engage the cleaving assembly with the connector joining assembly.

17. A method for splicing optical fibers using a self-aligning optical fiber insertion connector, comprising:
supporting an optical fiber between an optical fiber tool and a fiber aligning cavity;
translating the optical fiber tool towards the fiber aligning cavity to engage the optical fiber;
separating the optical fiber into a first optical fiber segment and a second optical fiber segment by translation of the optical fiber tool;
aligning the first and second optical fiber segments with respective first and second optical waveguides by translation of the optical fiber tool; and
splicing the first and second optical fiber segments to the respective first and second optical waveguides by translation of the optical fiber tool.

18. The method of claim 17, further comprising:
fixedly securing the optical fiber in place before translating the optical fiber tool towards the fiber aligning cavity.

19. The method of claim 18, wherein fixedly securing the optical fiber in place further comprises engaging the optical fiber using an adhesive.

20. The method of claim 17, wherein the optical fiber tool comprises a cleaving assembly and a connector joining assembly, and the method further comprises:
engaging the cleaving assembly with the connector joining assembly to align and splice the first and second optical fiber segments with the respective first and second optical waveguides.
